(19) United States
(12) Patent Application Publication
(10) Pub. No.: US 2012/0055314 A1
(43) Pub. Date: Mar. 8, 2012

(54) Resonant Apparatus for Conducting Sound Waves

(76) Inventors: Steven Lynn Gorman, Maryville, TN (US); Johnathan Charles Gorman, Maryville, TN (US)

(21) Appl. No.: 13/112,408

(22) Filed: May 20, 2011

Related U.S. Application Data
(60) Provisional application No. 61/379,763, filed on Sep. 3, 2010.

(51) Int. Cl. G10D 3/02

(52) U.S. Cl. 84/294

(57) ABSTRACT

The “Resonant Apparatus for Conducting Sound Waves” is for an electric string instrument, such as, but not limited to, a member of the guitar, bass, mandolin or violin family. The invention comprises a resonant apparatus and at least two connectors, to conduct sound waves from the vibrating string(s) of the musical instrument through the first connector to the resonant apparatus through the second connector to an electric pickup or plurality of pickups. The invention provides for proper phase alignment between the vibrating string or strings and the electric pickup or plurality of pickups.

### CROSS-REFERENCE TO RELATED APPLICATIONS

This application claims the benefit of U.S. Provisional Application 61/379,763, filed Sep. 9, 2010.

### STATEMENT REGARDING FEDERALLY-SPONSORED RESEARCH OR DEVELOPMENT

Not Applicable

### BACKGROUND OF THE INVENTION

1. Field of Invention

The present invention relates generally to a resonant apparatus for string instruments for the purpose of conducting sound waves from the vibrating strings of the instrument through the resonant apparatus.

More particularly, the present invention relates to a resonant apparatus for string instruments for the purpose of maintaining proper phase alignment between the sound waves produced by the vibrating strings of the instrument through the resonant apparatus. Maintaining phase alignment integrity between the sound waves and the resonant apparatus enhances the tonal integrity of the electric string instrument.

2. Description of the Related Art

In conducting sound waves from vibrating strings to electric pickup or plurality of pickups, sound waves typically may be distorted in three ways. First, sound waves may be dampened or lost when passing through relatively soft materials with radically different elastic properties such as wood, plastic, or springs. Second, sound waves may be reflected as they cross from metal to different materials such as wood, plastic or a plurality springs thereby setting up an unrealistic resonance. Third, sound waves may be modulated due to the electric pickup(s) being mounted on springs, plastic or wood and allowed to vibrate out of phase with the vibrating string.

Electric string instruments, such as electric guitars for one example, typically utilize metal strings. The body of the instrument is often made of wood or plastic of some type. As the vibrating metal strings pass over the wood or other non-metal material, the sound waves produced by the metal strings are altered to some degree, since the density of the wood or other non-metal material is not the same as the density of the metal string. The portion of the sound wave(s) that is reflected as it passes through the wood or other non-metal material undergoes a phase shift. The amount of the phase shift directly correlates with the density of the wood or other non-metal material.

In an effort to maintain sound wave phase integrity, electric string instruments have been constructed of all-metal materials. Often, these all-metal instruments have been crafted using metal of same or similar density to the strings used to make the sound waves of the instrument. These all-metal instruments, however, produced a sound unfavored by the human ear. The majority of human listeners, whether performer or audience, tend to prefer some reflection of the metal string(s) sound wave by allowing the sound wave to come in contact with either wood or some non-metal material. Modest reflection allows sufficient, minor phase shift to the sound waves so that the human ear hears the sound wave as “warmer” or more mellow in tone than the sound waves produced on an all-metal instrument.

The issue, then, becomes balancing transmission of the sound waves produced by the metal string or strings to the electric pickup or plurality of pickups in the electric string instrument, while allowing some modest reflection of the sound waves through the wood or non-metal body of the instrument. Modest reflection of the sound waves is inherently achieved if one constructs the instrument body from wood or other non-metal material. Thus the need is to maintain as much sound wave phase integrity as possible between the metal string and the electric pickup or plurality of pickups within the electric string instrument. In order to maintain sound wave phase integrity, one would create a path of uniform density through which the sound wave could travel, unimpeded, between the originating metal string and the electric pickup or plurality of pickups. Alternatively, one would create a path of uniform density through which the sound wave could travel, unimpeded, between the originating metal string and a resonant apparatus, the purpose of the resonant apparatus to maintain in-phase conduction of the sound wave.

### BRIEF SUMMARY OF THE INVENTION

The “Resonant Apparatus for Conducting Sound Waves” is for an electric string instrument, such as, but not limited to, a member of the guitar, bass, mandolin or violin family. The invention comprises a resonant apparatus and at least one connector, to conduct sound waves in-phase from the vibrating string(s) of the musical instrument through the at least one connector to the resonant apparatus. The invention provides for proper phase alignment between the vibrating string or strings and the resonant apparatus, thus enhancing clarity of tone within the sound wave by maintaining phase within the sound wave.

The present invention, in some of its embodiments, includes at least one vibrating string, at least one connector, and at least one resonant apparatus. It is most important that the entire assembly of said components is fixedly connected to one another to ensure proper transfer of sound energy. The resonant apparatus must be fixedly attached to the musical instrument in order to ensure proper acoustic conductivity of sound waves while simultaneously providing structural support. In some embodiments, in-phase conduction of the sound wave is continued, through the resonant apparatus by means of a second connector, directly to the electric pickup or plurality of pickups. In some embodiments, at least one adjustable connector is provided for each pickup. In some embodiments, one set of adjustable connectors is in compression while another set is in tension. This allows for precise adjustment of the pickup height while ensuring proper sound propagation into the pickup. Adjustable connectors also provide a means for the user of the instrument to determine whether to create a complete, in-phase sound wave from the vibrating string(s) to the electric pickup(s), or, alternatively, by adjusting the adjustable connector(s) between the resonant apparatus and the electric pickup(s), the user may stop the in-phase conduction of the sound wave at the resonant apparatus. Thus the invention provides for flexibility of in-phase sound wave conduction.

### BRIEF DESCRIPTION OF THE DRAWINGS

The above-mentioned and additional features of the invention will become more clearly understood from the following detailed description of the invention read together with the drawings in which:

FIG. 1 is a diagram illustrating a top view of a typical electric string instrument, showing six strings crossing over two electric pickups and attaching at the bridge;

FIG. 2 is a diagram illustrating an outer view of one embodiment of the present invention, showing the resonant apparatus attached to a typical electric string instrument;

FIG. 3 is a diagram illustrating a cross-section of one embodiment of the resonant apparatus;

FIG. 4 is a diagram illustrating a cross-section of another embodiment of the resonant apparatus; and

FIG. 5 is a diagram illustrating the alignment of strings and pickups in a typical string musical instrument.

### DETAILED DESCRIPTION OF THE INVENTION

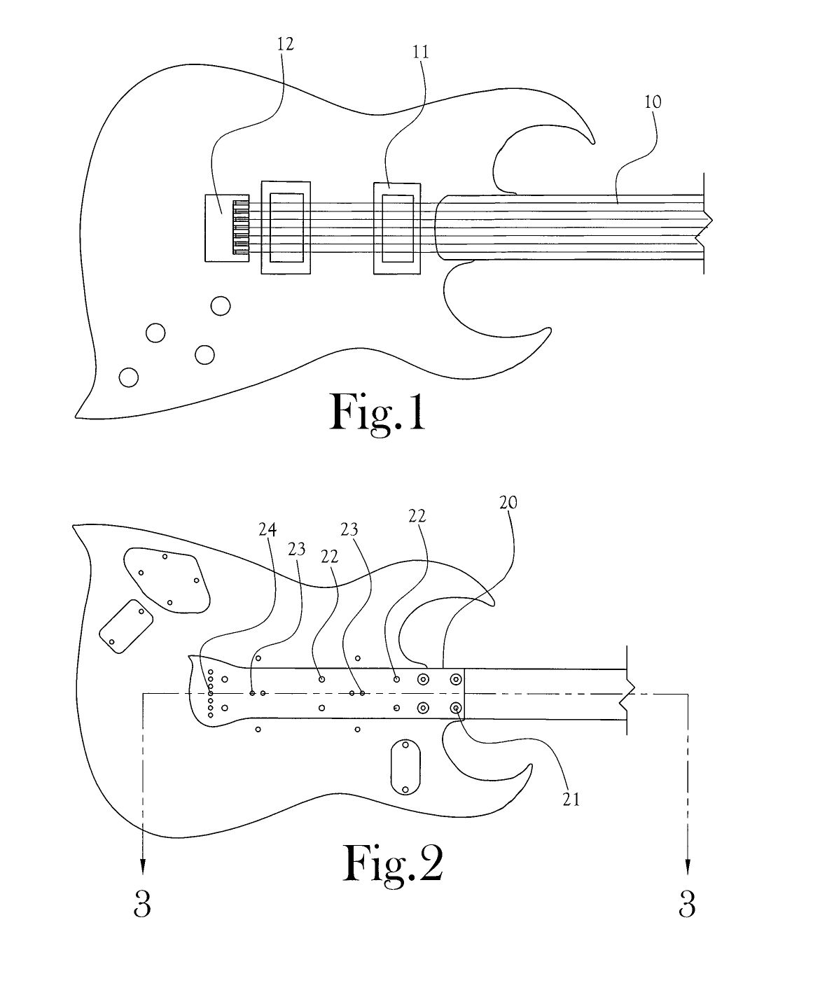

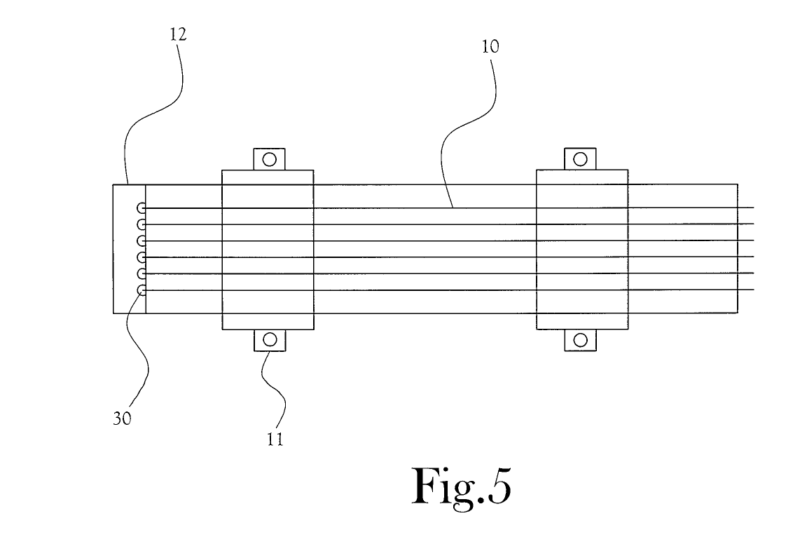

The present invention, in some of its embodiments, may be utilized on many string instruments, such as, but not limited to, an electric guitar, as illustrated in FIG. 1. More than one string 10 is shown, however, only but at least one string 10 is required for the invention to function. The string 10 is strung so as to be suspended over at least one electrical pickup 11. In some embodiments, string 10 is attached to the bridge 12 of the guitar and strung to the tuning keys (not shown) on the head (not shown) of the guitar. FIG. 5 is provided to illustrate how string 10 is typically oriented over electric pickup 11, with string 10 terminating at bridge 12 at points of attachment 30 within or upon bridge 12.

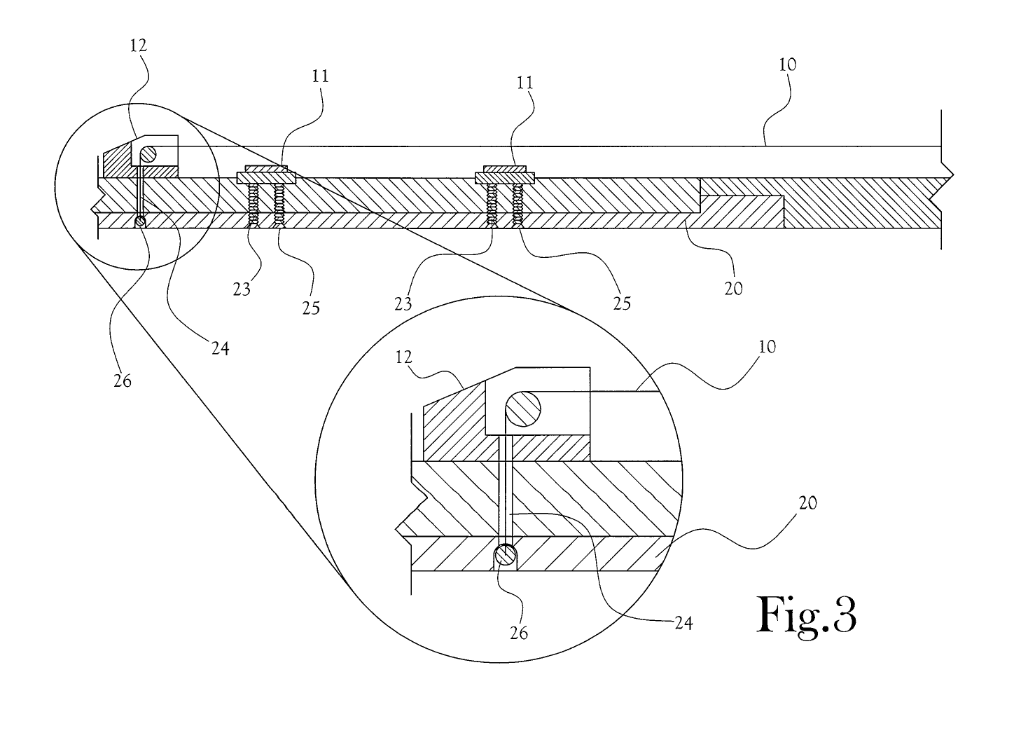

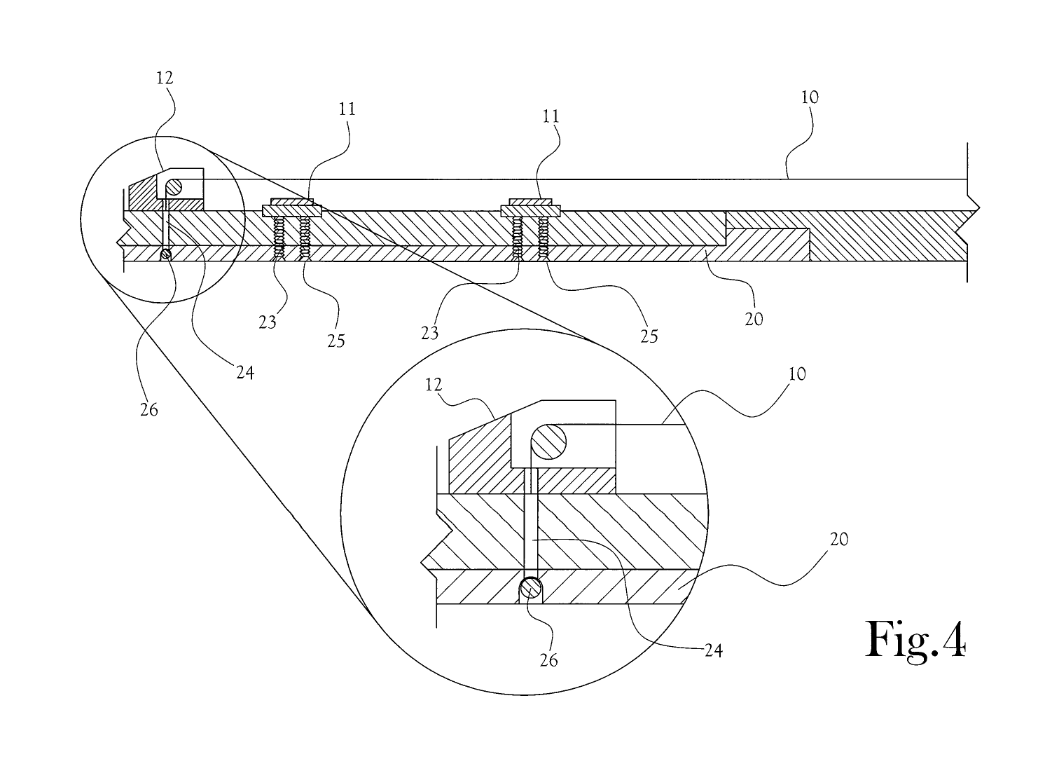

As illustrated in FIG. 2, the resonant apparatus 20 is fixedly attached to the string instrument at various points of attachment 21 and 22. In some embodiments, points of attachment 21 and 22 are holes drilled in the resonant apparatus 20 so that a means of fixedly attaching the resonant apparatus 20 may be inserted at points of attachment 21 and 22. In some embodiments, points of attachment 21 would include both the body and neck of the instrument, hence points of attachment 21 would be larger to accommodate a stronger means of fixedly attaching the resonant apparatus 20 to the body and neck of the instrument. (See FIG. 3 and FIG. 4) In some embodiments, points of attachment 23 are provided for at least one connector 25 to connect the resonant apparatus 20 to electric pickup 11. (See FIG. 3 and FIG. 4) In addition, points of attachment 24 are provided for string 10 to attach to resonant apparatus 20 by means of at least one connector 26.

In some embodiments, the point of attachment of string 10 may be at the base of the bridge 12, as illustrated in FIG. 4, where point of attachment 24 contains a terminal end of string 10 and point of attachment 24 connects the terminal end of string 10 to resonant apparatus 20 by means of at least one connector 26, as illustrated in FIG. 4. In other embodiments, string 10 may attach at connector 26, where connector 26 is bored in the center so as to allow string 10 to pass through connector 26 at point of attachment 24 and attach to connector 26, connector 26 thus attaching string 10 to resonant assembly 20, as illustrated in FIG. 3.

Irrespective of either type of attachment between string 10 and connector 26, effective functionality will occur for these components of the invention so long as string 10 is connected to resonant apparatus 20 by means of connector 26.

To effectively conduct a sound wave between the vibrating string 10 and the electric pickup 11, string 10 vibrates and transmits the sound wave through connector 26 to the resonant apparatus 20 and the resonant apparatus 20 continues conducting the sound wave through resonant apparatus 20 to point of attachment 23, where the sound wave is carried along connector 25 to the electric pickup 11. It is vital to optimal performance of this invention that resonant apparatus 20 be fixedly attached to the musical instrument, to avoid unwanted vibration of resonant apparatus 20 or any other invention part during conduction of the sound wave from string 10 through resonant apparatus 20 to electric pickup 11. In some embodiments, connector 25 is adjustable, to provide for optimal placement of electric pickup 11 relative to string 10. Utilizing an adjustable connector 25 also enables the user of the instrument to determine the terminal point of in-phase sound wave conduction, either within the resonant apparatus 20, or, if at least one point of attachment 23 and at least one connector 25 are included, the in-phase sound wave conduction will terminate in the electric pickup 11.

In some embodiments, the resonant apparatus 20 is a metal plate. In some embodiments, connector 25 is made of metal. In other embodiments, connector 26 is made of metal. In some embodiments, string 10, connector 26, resonant apparatus 20 and optional connector 25 are all constructed out of materials of like or very similar density, to provide optimal in-phase transfer of a sound wave from string 10 to electric pickup 11. In some embodiments, string 10, connector 26, resonant apparatus 20 and optional connector 25 are all constructed out of a metal. In some embodiments, string 10, connector 26, resonant apparatus 20 and optional connector 25 are all constructed out of a like metal, for example, steel.

As an example, such like or similar density material might be, but is not limited to, any metal from which a musical instrument string 10 is currently manufactured, such as, for one example, steel. If the string 10, connector 26, connector 25, and resonant apparatus 20 are all made of steel, as one example, the similar density of these like materials enables sound waves, generated by the manipulation of the string 10 by the player of the musical instrument, to travel in relative consonance from string 10 through connector 26 to resonant apparatus 20, and, optionally, through resonant apparatus 20 to connector 25 and through connector 25 to electrical pickup 11. This path of travel through like-density materials creates an unbroken and unfettered line between the string 10 and the resonant apparatus 20, and, in some embodiments, through the resonant apparatus 20 through the electric pickup 11, thus minimizing harmonic distortion, enhancing the purity of the sound wave and achieving greater clarity of tone, because the sound wave can travel in-phase.

In some embodiments, optional connector 25 is not included. In other embodiments, optional connector 25 is a means to fixedly connect resonant apparatus 20 to electric pickup 11. In other embodiments, optional connector 25 is adjustable, to provide flexibility with respect to at least two aspects. First, for user control in precisely adjusting the electric pickup 11, and, second, for user control over how much, if any, in-phase sound wave conduction occurs between resonant apparatus 20 and electric pickup 11.

While the present invention has been illustrated by description of some embodiments, and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus to conduct sound waves through a musical instrument, the musical instrument having at least one string mounted to vibrate above a first surface of the musical instrument and at least one electrical pickup mounted to the first surface to receive sound waves from the at least one string, the apparatus comprising:
a resonant element fixedly mounted to the musical instrument and spaced apart from the first surface to conduct sound waves produced by the at least one string; and
at least one connector to conduct sound waves from the at least one string to the resonant element.

2. The apparatus according to claim 1, further comprising a second surface of the musical instrument which is opposite to and spaced apart from the first surface, such that the resonant element is fixedly mounted to the second surface of the musical instrument.

3. The apparatus according to claim 1, further comprising a second at least one connector to conduct sound waves from the resonant element to the at least one electrical pickup.

4. The apparatus according to claim 2, further comprising a second at least one connector to conduct sound waves from the resonant element to the at least one electrical pickup.

5. The apparatus according to claim 1, wherein the resonant element or the first connector is comprised of like-density material to the at least one string.

6. The apparatus according to claim 2, wherein the resonant element or the first connector is comprised of like-density material to the at least one string.

7. The apparatus according to claim 3, wherein the resonant element, the first connector, or the second connector is comprised of like-density material to the at least one string.

8. The apparatus according to claim 4, wherein the resonant element, the first connector, or the second connector is comprised of like-density material to the at least one string.

9. The apparatus according to claim 1, wherein the resonant element or the first connector is comprised of a metal.

10. The apparatus according to claim 2, wherein the resonant element or the first connector is comprised of a metal.

11. The apparatus according to claim 3, wherein the resonant element, the first connector, or the second connector is comprised of a metal.

12. The apparatus according to claim 4, wherein the resonant element, the first connector, or the second connector is comprised of a metal.

13. The apparatus according to claim 1, wherein the resonant element or the first connector is comprised of steel.

14. The apparatus according to claim 2, wherein the resonant element or the first connector is comprised of steel.

15. The apparatus according to claim 3, wherein the resonant element, the first connector, or the second connector is comprised of steel.

16. The apparatus according to claim 4, wherein the resonant element, the first connector, or the second connector is comprised of steel.

17. The apparatus according to claim 1, wherein the resonant element or the first connector are comprised of like-density material.

18. The apparatus according to claim 2, wherein the resonant element or the first connector are comprised of like-density material.

19. The apparatus according to claim 3, wherein the resonant element, the first connector or the second connector are comprised of like-density material.

20. The apparatus according to claim 4, wherein the resonant element, the first connector or the second connector are comprised of like-density material.

21. The apparatus according to claim 3, wherein at least one connector is adjustable.

22. The apparatus according to claim 4, wherein at least one connector is adjustable.

23. The apparatus according to claim 7, wherein at least one connector is adjustable.

24. The apparatus according to claim 8, wherein at least one connector is adjustable.

25. The apparatus according to claim 11, wherein at least one connector is adjustable.

26. The apparatus according to claim 12, wherein at least one connector is adjustable.

27. The apparatus according to claim 15, wherein at least one connector is adjustable.

28. The apparatus according to claim 16, wherein at least one connector is adjustable.

29. The apparatus according to claim 19, wherein at least one connector is adjustable.

30. The apparatus according to claim 20, wherein at least one connector is adjustable.
